(19) United States
(12) Patent Application Publication
(10) Pub. No.: US 2009/0055142 A1
(43) Pub. Date: Feb. 26, 2009

(54) METHOD AND APPARATUS FOR ESTIMATING MAN-HOURS

(75) Inventors: Izumi Nitta, Kawasaki (JP); Toshiyuki Shibuya, Kawasaki (JP); Katsumi Homma, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 12/190,205

(22) Filed: Aug. 12, 2008

(30) Foreign Application Priority Data
Aug. 15, 2007 (JP) 2007-211760

(51) Int. Cl. G06F 7/60; G06F 17/10

(52) U.S. Cl. 703/2

(57) ABSTRACT

A method for estimating a man-hours of an entire project having a series of tasks with a computer includes, inputting an estimated man-hours of the each task, acquiring model functions for extracting estimation errors included in the estimated man-hours of the each task based on an attribute of a worker who performs the each task, calculating a probability density distribution representing estimation errors depending on the attribute and a probability density distribution representing modeling errors depending on methods for estimating the man-hours for each task using the model functions, calculating man-hours of the entire project having a series of tasks for the each task using statistical methods to accumulate the probability density distribution representing estimation errors and the probability density distribution representing the modeling errors, and outputting calculating results of man-hours of the entire project to a output device.

### CROSS-REFERENCE TO RELATED APPLICATIONS

This application is based upon and claims the benefit of priority of the prior Japanese Patent Application No. 2007-211760, filed on Aug. 15, 2007, the entire contents of which are incorporated herein by reference.

### BACKGROUND OF THE INVENTION

1. Field of the Invention

An aspect of the invention is related to a method and an apparatus for estimating man-hours of an entire project which consists of series of two or more tasks.

2. Description of the Related Art

Conventionally, methods for estimating man-hours have been used that break down an entire development project having a plurality of tasks into work units. The man-hours of the entire project are estimated by using both the estimated man-hours of each task and a workflow which represents a relationship before and after the task. A method, represented by the Program Evaluation and Review Technique (PERT), in which man-hours of an entire development project are estimated by taking account of variations in estimated man-hours of each task, has been used as well.

Recently, tools which applied these methods and automated man-hours estimation for an entire development project have been provided. For example, tools which obtain a function quantity based on function information managed by each development area, and estimate man-hours of an entire development project by using the quantity, are provided for software development (e.g., refer to Japanese Laid-open Patent Publication No. 2002-222080).

Tools for estimating man-hours of an entire development project by referring to actual man-hours of a similar past project are also provided (e.g., refer to Japanese Laid-open Patent Publication No. H11-203351).

These tools enable the accuracy of man-hours estimation to be improved, because the amount of tasks and costs in a software development are estimated by using actual values in the same development field (i.e., a similar project).

### SUMMARY OF THE INVENTION

According to an aspect of the present invention, a method for estimating man-hours of an entire project having a series of tasks with a computer includes,

inputting an estimated man-hours of each task,

acquiring model functions for extracting estimation errors included in the estimated man-hours of each task based on an attribute of a worker who performs the task,

calculating a probability density distribution representing estimation errors depending on the attribute and a probability density distribution representing modeling errors depending on methods for estimating the man-hours for each task using the model functions,

calculating man-hours of the entire project having a series of tasks for each task using statistical methods to accumulate the probability density distribution representing estimation errors and the probability density distribution representing the modeling errors, and

outputting calculating results of man-hours of the entire project to an output device.

Additional objects and advantages of the invention (embodiment) will be set forth in part in the description which follows, and in part will be obvious from the description, or may be learned by practice of the invention. The object and advantages of the invention will be realized and attained by means of the elements and combinations particularly pointed out in the appended claims.

It is to be understood that both the foregoing general description and the following detailed description are exemplary and explanatory only and not restrictive of the invention, as claimed.

### BRIEF DESCRIPTION OF THE DRAWINGS

FIG. 1 illustrates an overview of an embodiment of the present invention;

FIG. 2 illustrates a hardware configuration of a man-hours estimation apparatus of an embodiment;

FIG. 3 illustrates a stored content of an attribute information database (DB) of an embodiment;

FIG. 4 is an example of a correlation table (1);

FIG. 5 illustrates a functional configuration of a man-hours estimation apparatus of an embodiment;

FIG. 6 illustrates an example of a series of tasks;

FIG. 7 illustrates an overview of an update process;

FIG. 8 is a flow chart illustrating a process to estimate man-hours by a man-hours estimation apparatus;

FIG. 9 is an example of estimated man-hours of each task (1);

FIG. 10 is an example of a correlation coefficient (1);

FIG. 11 illustrates calculation results of a first calculation unit (1);

FIG. 12 is an example of estimated man-hours of each task (2);

FIG. 13 is an example of a correlation table (2);

FIG. 14 is an example of a correlation coefficient (2);

FIG. 15 illustrates calculation results of a first calculation unit (2);

FIG. 16 is an example of estimated man-hours of each task (3);

FIG. 17 is an example of a correlation table (3);

FIG. 18 is an example of a correlation coefficient (3);

FIG. 19 illustrates calculation results of a first calculation unit (3);

FIG. 20 illustrates an output format displayed on a display;

FIG. 21 illustrates estimation results of conventional techniques.

### DETAILED DESCRIPTION OF THE PREFERRED EMBODIMENTS

Reference may now be made in detail to embodiments of the present invention, examples of which are illustrated in the accompanying drawings, wherein like reference numerals refer to like elements throughout.

The conventional techniques described above do not take variations caused by the experience and skill of an individual worker, and by the method used to estimate man-hours, sufficiently into account. Consequently, such variations may lead to larger estimation errors and lower accuracy of man-hours estimation for an entire development work.

Particularly, man-hours of each task may tend to vary substantially depending on the experience and skill of a worker in a software development compared with that of hardware and construction designs. This leads to an increase of estimation errors caused by variations. Thus, improving accuracy of man-hours is important.

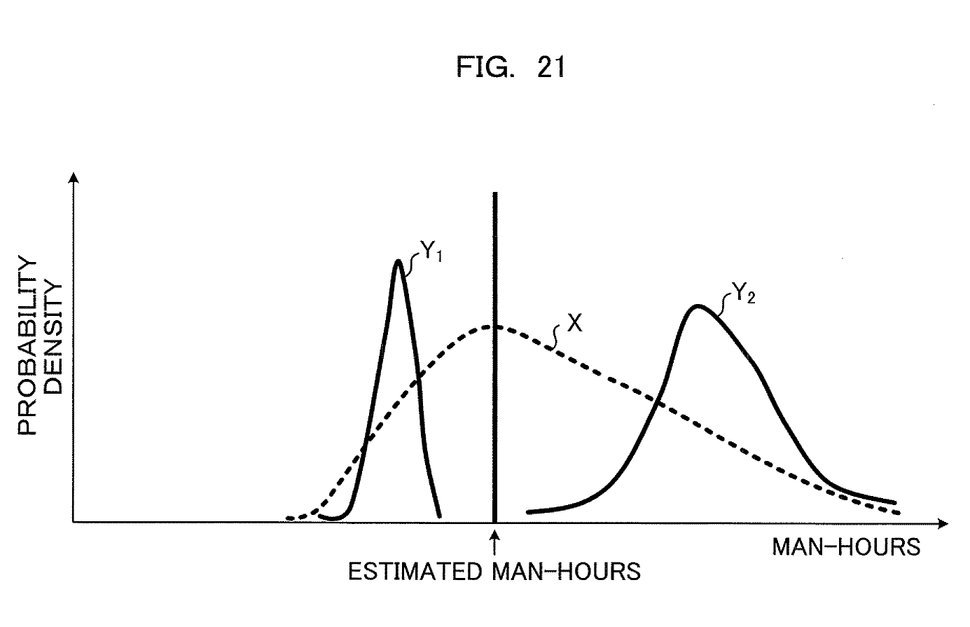

FIG. 21 is an explanatory diagram illustrating estimation results of conventional techniques. In FIG. 21, a probability density distribution “X” indicates variations in man-hours of a work estimated by a predetermined estimation method. A probability density distribution “Y₁” indicates variations in actual values achieved by a skilled worker “A”. A probability density distribution “Y₂” indicates variations in actual values achieved by a new worker “B”. The actual value means actual man-hours (i.e., a result man-hour) spent for a work.

According to the probability density distribution “Y₁”, the skilled worker “A” generally spends fewer man-hours than the estimated man-hours (mean value of a probability density distribution “X”), with smaller variations. According to the probability density distribution “Y₂”, the new worker “B” spent more man-hours than the estimated man-hours with larger variations.

As mentioned above, the man-hours required for a task largely vary depending on a worker's experience and skill. Therefore if such variations depending on experience and skill are not sufficiently taken into account, a man-hours estimation error increases and accuracy of man-hours estimation of an entire project having a series of tasks is reduced.

A method and an apparatus to improve accuracy of man-hours estimations are explained in an embodiment of the present invention.

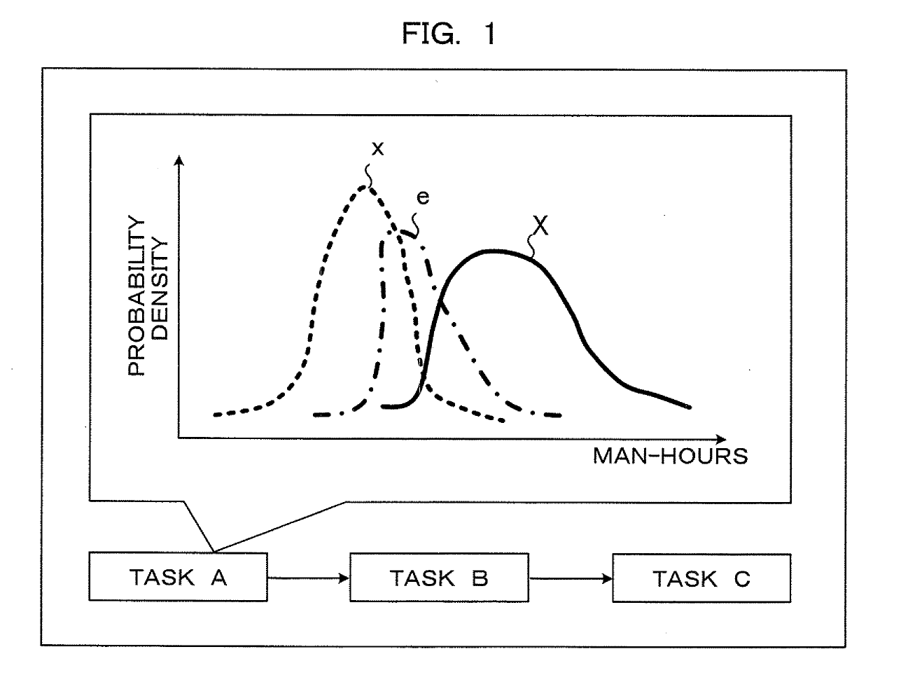

FIG. 1 is an explanatory diagram illustrating an overview of an embodiment of the present invention. As an example, a series of tasks “A”, “B”, and “C” are explained here.

In FIG. 1, a probability density distribution X indicates variations in man-hours of a task “A” estimated by a predetermined estimation method. A probability density distribution “x” indicates variations in modeling errors of estimated man-hours depending on the above estimation method. A probability density distribution “e” indicates variations in estimation errors of estimated man-hours depending on an attribute of a worker who performs the task “A”.

Generally, man-hours of tasks “A” to “C” largely vary depending on a worker's attributes such as experience and skill. In this embodiment, therefore, we estimate man-hours of a series of tasks by taking account of estimation errors depending on attributes of a worker who performs tasks “A” to “C”. More specifically, the probability density distribution “X” is separated into a probability density distribution “x” and a probability density distribution “e”. Then the probability density distributions “X”=“x”+“e” is used.

The same applies to tasks “B” and “C” as the task “A”. That is to model errors separately depending on estimation methods and estimation errors depending on attributes of a worker, and regard them as the estimated man-hours of the tasks “B” and “C” respectively. Thus, the accuracy of man-hours estimation is improved by taking account of estimation errors included in estimated man-hours of tasks “A” to “C” depending on attributes of workers and then estimating man-hours of an entire project having a series of tasks.

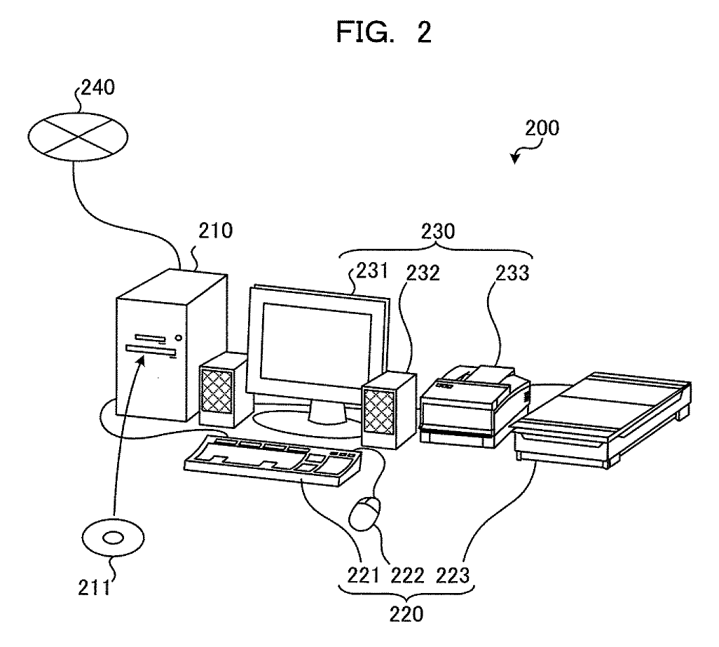

FIG. 2 is an explanatory diagram illustrating a hardware configuration of a man-hours estimation apparatus.

In FIG. 2, a man-hours estimation apparatus 200 is comprised of a computer 210, an input device 220, and an output device 230. The man-hours estimation apparatus 200 can be connected to a network 240 such as a local area network (LAN), a wide area network (WAN), and the Internet via a router or a modem (not shown in FIG. 2)

The computer 210 includes a central processing unit (CPU), memories, and an interface. The CPU controls the man-hours estimation apparatus 200. The memories include a read only memory (ROM), a random access memory (RAM), a hard disk (HD), an optical disk 211 and a flash memory. Some memories are used as a work area of the CPU.

Various programs are stored in the memory and are loaded by an instruction of the CPU. Disk drives control read and write of the HD and the optical disk 211 respectively. The optical disk 211 and the flash memory are attachable and detachable to the computer 210. The interface controls input from the input device 220, output to the output device 230, and sends and receives to and from the network 240.

The input device 220 may include a keyboard 221, a mouse 222, and a scanner 223. The keyboard 221 provides keys for inputting characters, numbers, and various instructions and performs data input. A touch-panel keyboard may be used. The mouse 222 moves a cursor, selects area, moves a window, and changes the size, etc. The scanner 223 optically reads an image. The optically read image is taken as image data and stored in the memory of the computer 210. The scanner 223 can be provided with an optical character reader (OCR) function.

The output device 230 may include a display 231, a speaker 232, and a printer 233. The display 231 displays a cursor, an icon, and a toolbox, and data such as a text, an image, and functional information. The speaker 232 outputs sounds such as sound effects and readout sounds. The printer 233 prints image and text data.

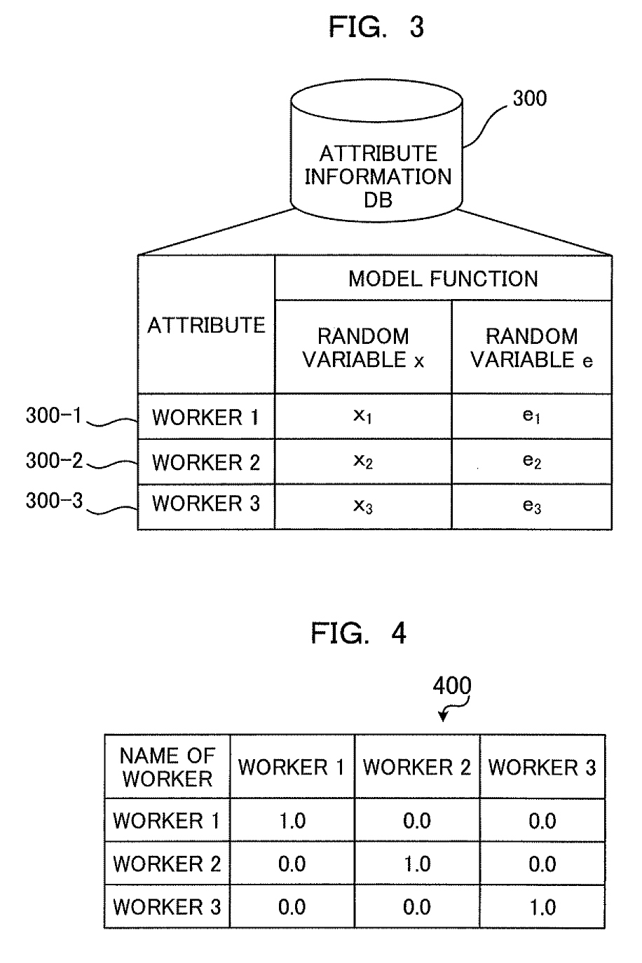

FIG. 3 is an explanatory diagram illustrating contents stored in an attribute information database (DB). In FIG. 3, an attribute information DB300 stores attribute information “300-1 to 300-n” by attribute. The attribute indicates characteristics of a worker who performs a task. A name of each worker (workers 1 to n) is used here to indicate an attribute.

Each attribute information “300-1 to 300-n” provides model functions to extract estimation errors from the estimated man-hours of each task for the workers 1 to n. More specifically, the model functions include random variables “e₁ to eₙ” representing estimation errors depending on workers 1 to n, and random variables “x₁ to xₙ” representing modeling errors depending on estimation methods used to estimate man-hours of each task.

The random variables “e₁ to eₙ” are provided beforehand for each of the attributes (workers 1 to n). The random variables “x₁ to xₙ” are provided beforehand for each of the methods for estimating man-hours of each task. Here, the random variables “x₁ to xₙ” representing modeling errors depending on a particular estimation method are described. Specific examples of random variables “e₁ to eₙ” and random variables “x₁ to xₙ” are explained later.

FIG. 4 is an explanatory diagram illustrating a specific example of a correlation table. In this embodiment, a correlation table 400 is stored in the attribute information DB300 shown in FIG. 3.

In FIG. 4, a correlation table 400 includes correlation coefficients representing correlations between attributes of workers 1 to 3 of each task. The attribute here is a worker's name (i.e., workers 1 to 3). The correlation coefficients are represented by integer values from 0.0 to 1.0, and 0.0 indicates the lowest level of correlation while 1.0 indicates the highest level of correlation between attributes.

More specifically, the correlation coefficients between attributes of workers with the same name are 1.0 and those between different workers are 0.0. A correlation coefficient between attributes can be set optionally. For example, a high correlation coefficient is set when years of experience are closer between workers, while a low correlation coefficient is set when years of experience are far apart between workers.

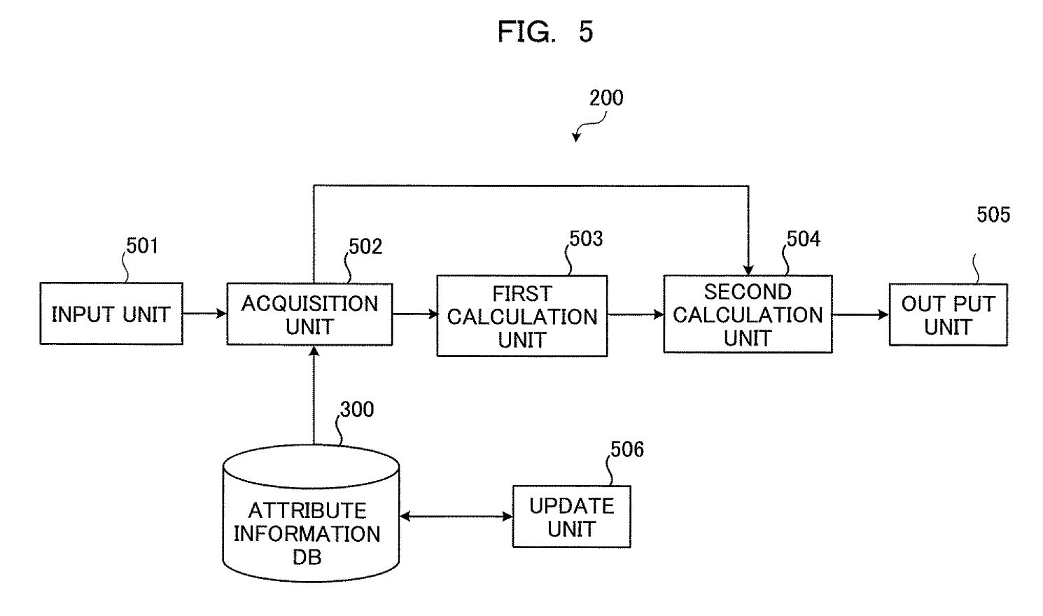

FIG. 5 is a block diagram illustrating a functional configuration of a man-hours estimation apparatus. In FIG. 5, a man-hours estimation apparatus 200 includes an attribute information DB 300, an input unit 501, an acquisition unit 502, a first calculation unit 503, a second calculation unit 504, an output unit 505, and an update unit 506.

These units 501 to 506 can realize their functions by causing a CPU to execute corresponding programs stored in a memory. Output data from functions 501 to 506 may be stored in an output memory. Referring to FIG. 5, a connected functional configuration reads data from the output memory output by a connecting function and causes the CPU to execute the program corresponding to the function. An arrow points from the connecting function to the connected functional configuration.

The man-hours estimation apparatus 200 estimates man-hours of an entire project having a series of tasks. The “task” means actual work performed at each process when a project is divided into a plurality of processes. In software development, for example, when each function of software is enabled by dividing the function into a plurality of modules; each “task” means work to develop a program for each module.

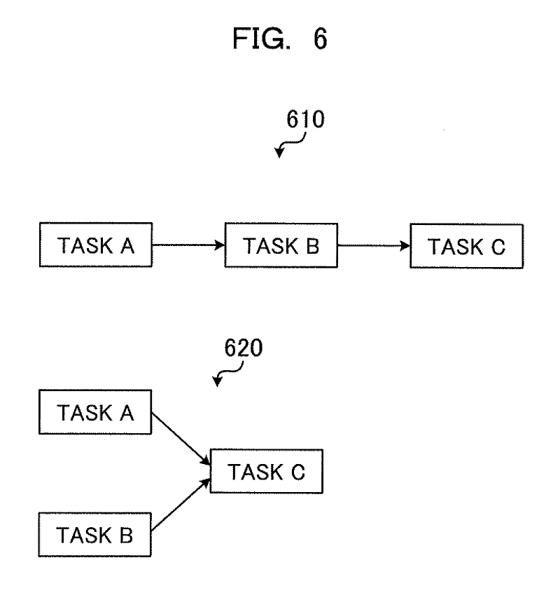

A “series of tasks” means a work set having a plurality of tasks, and the tasks are connected either in parallel or in series. Now, a specific example of a series of tasks is explained. FIG. 6 is an explanatory diagram illustrating a specific example of a series of tasks. In FIG. 6, a diagram 610 and a diagram 620 show a series of tasks having tasks “A”, “B”, and “C”.

In the diagram 610, tasks are connected in series. This means the task “B” starts after task “A” is completed, and then task “C” starts after the task “B” is completed. In the diagram 620, a task “A” and a task “B” are connected in parallel. This means the tasks “A” and “B” are performed in parallel, and the task “C” starts when both the task “A” and the task “B” are complete.

Firstly an input unit 501 accepts input of estimated man-hours of each task. The estimated man-hours are estimated with man-hours of each task (e.g., a mean value of a probability density distribution “X” in FIG. 21) obtained by a predetermined estimation method. More specifically, a user's operation of an input device 220 such as a keyboard 221 or a mouse 222 shown in FIG. 2 causes the input unit 501 to accept estimated man-hours of each task.

An acquisition unit 502 acquires model functions based on an attribute of a worker who performs the task to extract an estimation error included in estimated man-hours of each task input at the input unit 501. The attribute means characteristics of a worker who performs each task. More specifically, the attribute may be personal information (e.g., a name, an age, and a department), or proficiency such as years of experience and skill in order to identify a worker.

Information representing attributes of each worker (e.g., personal information and proficiency) may be directly input to the man-hours estimation apparatus 200. The information representing attributes of each worker may be input, for example, by linking the attributes with estimated man-hours. The information representing attributes of each worker may also be pre-stored in a storage area such as a read only memory (ROM) or a random access memory (RAM).

Model functions are random variables representing estimation errors depending on an attribute of a worker, and random variables representing modeling errors depending on estimation methods. The acquisition unit 502, for example, reads information representing an attribute of a worker who performs each task from a storage area. The acquisition unit 502 acquires the random variables “e” and “x” based on the information. The random variables “e” and “x” are Stored by being linked with each worker's attribute from the attribute information DB300 shown in FIG. 3.

Specific examples of random variables “e” and “x” are explained. Expressions 1 to 6 below show random variables “e₁” to “e₃” representing estimation errors depending on attributes of workers 1 to 3 and random variables “x₁” to “X₃” representing modeling errors depending on estimation methods for estimating man-hours. Note that “T” is estimated man-hours of each task, while “r1” is a normal distribution of (a mean value, a standard deviation)=(0,1).

e₁=0.07×T*r1+0.03×T (1)

x₁=1.0×T+1 (2)

e₂=0.1×T×r1 (3)

x₂=0.75×T+1 (4)

e₃=0.07×T×r1 (5)

x₃=1.2×T+1 (6)

A first calculation unit 503 calculates, for each task, both a probability density distribution and a distribution by using model functions acquired by the acquisition unit 502. The probability density distribution represents estimation errors depending on attributes, while the distribution represents modeling errors depending on estimation methods for estimating man-hours. More specifically, for each task “i”, the first calculation unit 503 calculates probability density distributions “eᵢ” and “xᵢ” by assigning estimated man-hours of each task into random variables “eᵢ” and “xᵢ” obtained by the acquisition unit 502.

For example, assume that a worker of a task is a worker 1 and estimated man-hours of the task are “10”. In this case, a probability density distribution “e₁” representing estimation errors depending on the worker 1 and a probability density distribution “x₁” depending on the method which estimated man-hours “10” are calculated by applying the estimated man-hours “10” to parameters T in the above expressions (1) and (2).

A second calculation unit 504 calculates man-hours of an entire project having a series of tasks by using statistical methods to accumulate the probability density distribution representing estimation errors and the distribution representing modeling errors calculated by the first calculation unit 503. More specifically man-hours of an entire project having a plurality of tasks are calculated by using statistical methods to accumulate mean values and standard deviations for a probability density distribution “e” and a probability density distribution “x” calculated for each task by the first calculation unit 503.

More specifically, a mean value of man-hours of an entire project having a series of tasks is calculated by using statistical methods to accumulate mean values of probability density distributions “e” and “x” for each task. A standard deviation for estimated man-hours of an entire project having a series of tasks is calculated by using statistical methods to accumulate standard deviations of probability density distributions “e” and “x” for each task.

As a result, the man-hours of an entire project are estimated based on the calculated mean values and standard deviations for calculated man-hours estimation of an entire project having a series of tasks. Specific methods to statistically accumulate a probability density distribution representing estimation errors and a probability density distribution representing modeling errors are described later in Examples 1 to 3.

The acquisition unit 502 acquires a correlation coefficient representing a correlation between tasks in terms of estimation errors based on an attribute of a worker who performs each task. More specifically, the acquisition unit 502 acquires a correlation coefficient representing a correlation between tasks in terms of estimation errors based on attributes of a worker who performs each task, for example, by referring to a correlation table shown in FIG. 4.

A correlation coefficient representing a correlation between tasks may be acquired according to a predefined rule. For example, assume that a focus is on a specific task among a series of tasks. A correlation coefficient of tasks before and after the task may be acquired by taking account of the correlation between the tasks before and after the task. A correlation coefficient between serially connected tasks may be acquired by taking account of a correlation between serially connected tasks.

More specifically, the acquisition unit 502 may acquire a correlation coefficient representing a correlation between tasks immediately before and/or after each task by referring to a sequence of a series of tasks. A correlation coefficient representing a correlation between tasks parallel connected may be acquired by referring to a sequence of a series of tasks.

Information that identifies a sequence of each task (e.g., diagrams 610 and 620 shown in FIG. 6) may be directly input to the man-hours estimation apparatus 200, or such information may be pre-stored in a memory such as a read only memory (ROM) or a random access memory (RAM). More specifically, for example, the acquisition unit 502 acquires a correlation coefficient between tasks according to a predefined rule by referring to the diagrams 610 and 620.

The second calculation unit 504 calculates man-hours of an entire project having a series of tasks based on the correlation coefficient acquired by the acquisition unit 502. More specifically, by taking account of correlations between tasks, a probability density distribution representing estimation errors and the distribution representing modeling errors for each task are accumulated by using statistical methods.

Specific methods to statistically accumulate a probability density distribution representing estimation errors and a probability density distribution representing modeling errors by taking account of correlations between tasks are explained later in Examples 2 and 3. When a correlation between attributes is not defined in the correlation table 400 etc., a predefined correlation coefficient (e.g., “0.5”) may be used to calculate man-hours of an entire project having a series of tasks.

The output unit 505 outputs the result calculated by the second calculation unit 504. The output form of the output unit 505 may be a screen display on the display 231, a printout by the printer 233, data output (i.e., storage) to a memory, or transmission to an external computer.

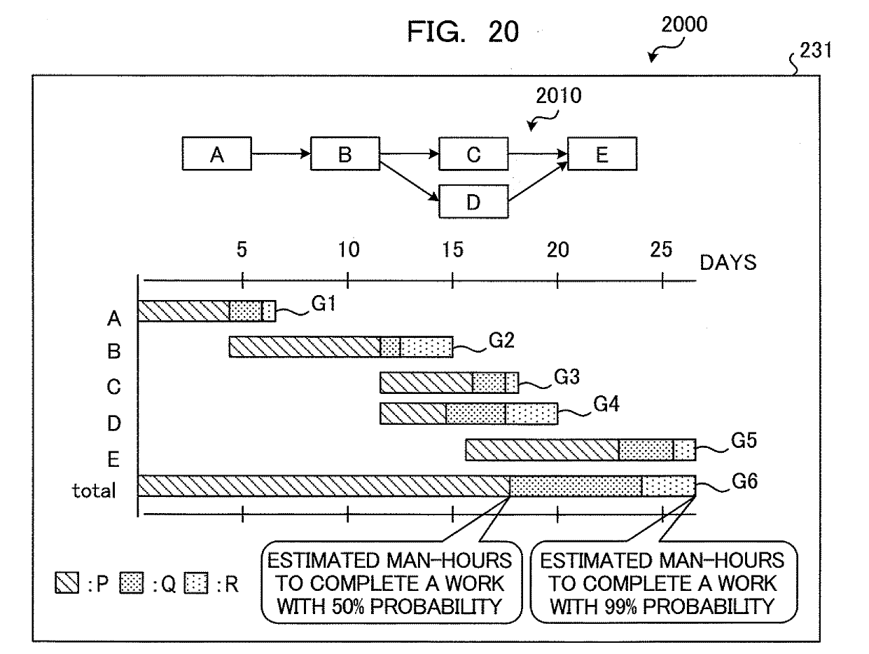

More specifically, the output unit 505 may display a probability density distribution representing man-hours of an entire project having a series of tasks and the distribution representing estimation errors included in the man-hours of the entire project on the display 231. A specific example of the output form of the output unit 505 is explained later in an Example 4 (FIG. 20).

The update unit 506 updates parameter values in model functions retained by being linked to a worker's attribute of a relevant task based on estimated man-hours and actual man-hours spent for the work. More specifically, for example, the parameter value is updated by using an existing fitting method based on man-hours estimated in past and actual man-hours spent for the work.

When parameter values are updated by the update unit 506, the acquisition unit 502 may acquire the updated model functions retained by being linked to the attribute. A specific example of an update process by the update unit 506 is explained. As an example, an update process when a worker 1 performs a task “A” is explained here.

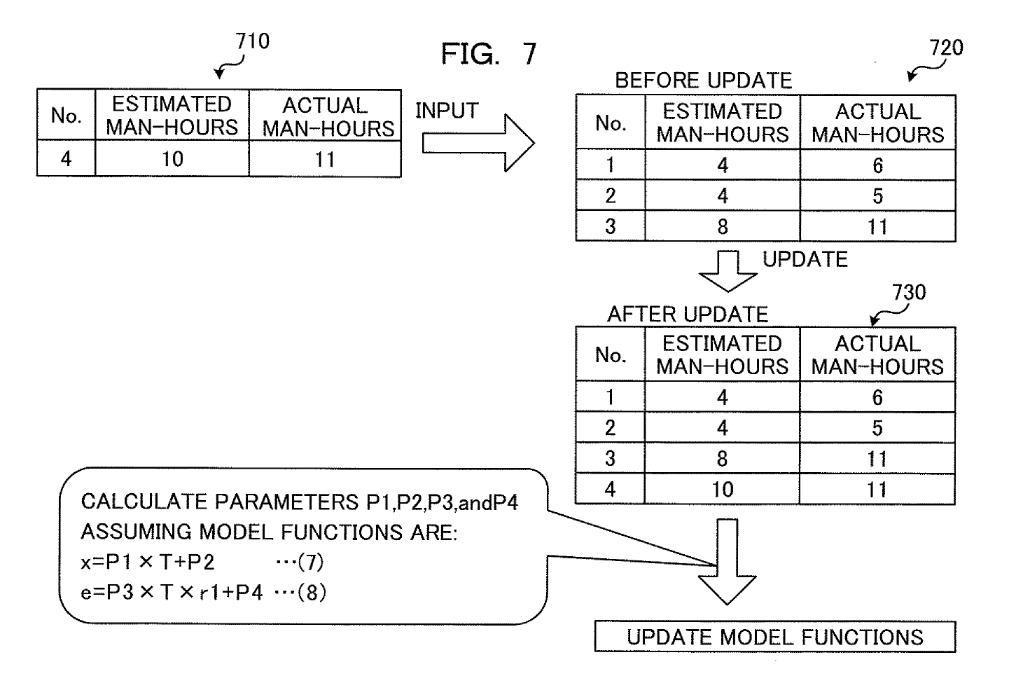

FIG. 7 is an explanatory diagram illustrating an overview of an update process. Firstly, an input information 710 representing estimated man-hours of the task “A” and actual man-hours spent by the worker 1 for the task “A” is input. More specifically, for example, the input information 710 is input by user operation of the input device 220 such as the keyboard 221, or the mouse 222.

Then, based on the input information 710, a content of history information 720 to which man-hours estimated in past and actual man-hours spent regarding to the task “A” of the worker 1 are recorded is updated to history information 730. The history information 720 and 730 store man-hours of task “A” estimated in past and actual man-hours spent at that time by the worker 1 in time sequence (i.e., No.1 to No.2, and . . . ). The history information 720 and 730 is stored in the attribute information DB300 shown in FIG. 3.

Next, according to the updated history information 730, parameter values in model functions (e.g., expressions (1) and (2)) linked to the worker 1 are updated. More specifically, model functions are assumed to be the expressions (7) and (8) shown below and parameters P₁, P₂, P₃, and P₄ are recalculated.

x=P₁×T+P₂ (7)

e=P₃×T×r1+P₄ (8)

When recalculation of parameters P₁, P₂, P₃ and P₄ is completed, the parameter values in above expressions (1) and (2) are updated to the recalculated value.

An example of recalculation of parameters P₁, P₂, P₃, and P₄ is shown. Estimated man-hours and actual man-hours stored in the history information 730 are described in time sequence as follows:
(estimated man-hours, actual man-hours)=(tᵢ, t′ᵢ) where, (i=1 . . . n).

Firstly using the expression (9) below, difference of estimated man-hours and actual man-hours are calculated.

Δᵢ=(tᵢ−t′ᵢ)/tᵢ (9)

After that a normal distribution to approximate “Δᵢ” is calculated, and a mean value “μ” and a standard deviation “σ” of the normal distribution are obtained. The mean value “μ” and the standard deviation “σ” obtained here are applied to values for above parameters P₃ and P₄ (P₃=σ, P₄=μ). Then when on the normal distribution “Δᵢ” is located is calculated, and amount of estimation errors of estimated man-hours are subtracted from t′ᵢ by using an expression (10) shown below.

xᵢ=tᵢ−T×(P₃×Δᵢ+P₄) (10)

Then, values for parameters P₁ and P₂ are calculated so that (tᵢ, xᵢ) are represented by an expression (11) shown below by using a least-squares method.

xᵢ=P₁×tᵢ+P₂ (11)

Finally, recalculated parameters P₁, P₂, P₃, and P₄ are applied to above expressions (7) and (8). Then the model functions obtained by applying the recalculated parameters P₁, P₂, P₃, and P₄ to above expressions (7) and (8) shall be updated model functions linked to the worker 1.

Thus, model functions linked to attributes of a worker (e.g., above expressions (1) to (6)) may be changed depending on estimated man-hours of a task and actual man-hours spent by the worker. This enables model functions to be updated depending on change of, for example, proficiency of a worker, thereby allowing use of appropriate model functions depending on attributes of the relevant worker when calculating estimated man-hours.

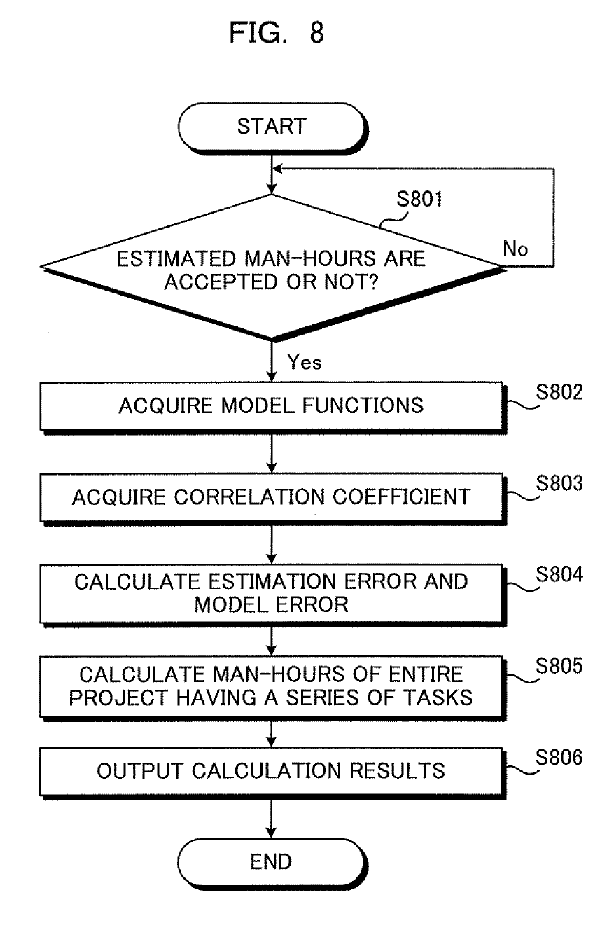

FIG. 8 is a flow chart illustrating processes to estimate man-hours by the man-hours estimation apparatus. Firstly, in the flow chart of FIG. 8, an input unit 501 determines whether estimated man-hours of each task having a series of tasks are accepted or not (Operation S801).

Now, the apparatus 200 waits for input of estimated man-hours of each task (Operation S801: No). When the estimated man-hours are input (Operation S801: Yes), an acquisition unit 502 acquires model functions to extract an estimation error included in estimated man-hours of each task input by the input unit 501 based on attributes of a worker who performs each task (Operation S802).

Moreover the acquisition unit 502 acquires a correlation coefficient representing a correlation between tasks in terms of estimation errors based on attributes of a worker who performs each task (Operation S803). Then a first calculation unit 503 calculates, for each task, both a probability density distribution representing estimation errors depending on attributes and the distribution representing modeling errors depending on estimation methods for estimating man-hours (Operation S804).

Then a second calculation unit 504 calculates man-hours of an entire project having a series of tasks (S805) by statistically accumulating the probability density distribution representing estimation errors of each task and the distribution representing modeling errors calculated at Operation S804 based on the coefficient correlation acquired at Operation S803.

An output unit 505 outputs results calculated by the second calculation unit 504 (Operation S806), thereby completes a series of processes in this flow chart. Note that the execution order of Operations S802 and S803 may be reversed or executed in parallel.

As explained above, according to the embodiment of the present invention, man-hours of an entire project having series of tasks can be estimated by taking account of estimation errors depending on a worker's experience and skill. At this time, man-hours can be estimated by taking account of a correlation between tasks depending on a worker's experience and skill.

Model functions stored in the attribute information DB300 by being linked to attributes of a worker can be updated depending on actual man-hours spent for a task by the worker. As a result, the model functions are updated in response to change of the worker's skill level thereby enables estimation of man-hours using appropriate model functions depending on the worker's skill level.

### EXAMPLE 1

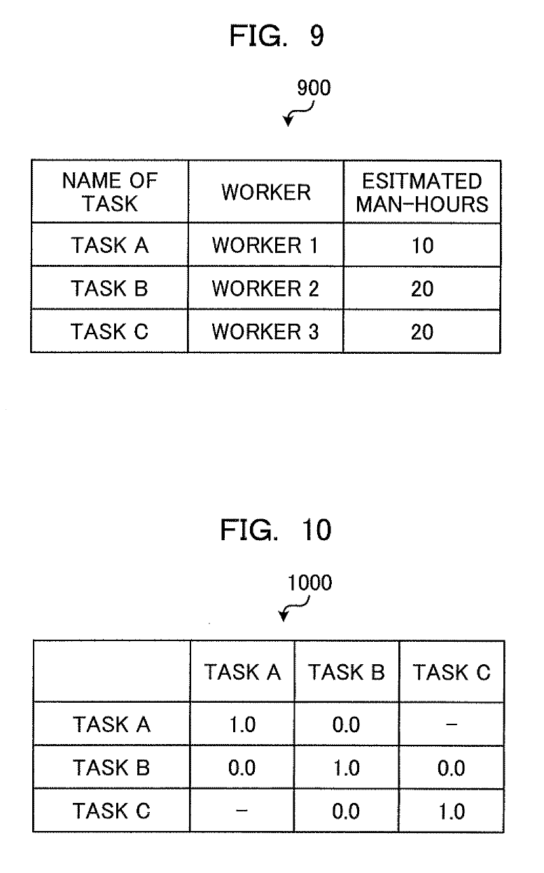

Example 1 of the above embodiment is explained. In Example 1, man-hours of an entire project having a series of tasks are estimated using an example shown in a diagram 610 in FIG. 6. FIG. 9 is an explanatory diagram illustrating an example of estimated man-hours of each task (1). In FIG. 9, input information 900 is information indicating workers 1 to 3 and the estimated man-hours by tasks “A” to “C”.

Specifically, the following is shown: estimated man-hours of “10 days” when a worker 1 performs a task “A”, that of “20”days when a worker 2 performs a task “B”, and that of “20”days when a worker 3 performs a task “C” respectively. These estimated man-hours are estimated by using a predetermined method.

The input information 900 is directly input by a user to a man-hours estimation apparatus 200. Then, an input unit 501 (refer to FIG. 5) accepts the input information 900. After that, an acquisition unit 502 acquires model functions from the attribute information DB300 based on attributes of workers (workers 1 to 3) of tasks “A” to “C” respectively. Specifically, the acquisition unit 502 acquires above expressions (1) to (6).

Moreover, the acquisition unit 502 acquires a coefficient correlation representing a correlation between tasks in terms of estimation errors based on attributes of workers (workers 1 to 3) who perform tasks “A” to “C” respectively by referring to a correlation table 400 shown in FIG. 4. The correlation coefficient representing a correlation between tasks immediately before and/or after each task is acquired by referring to the diagram 610.

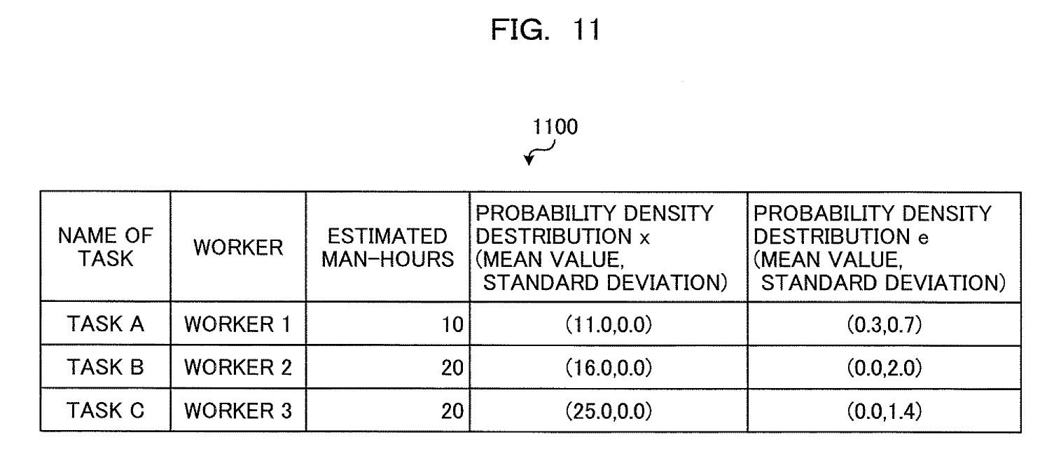

FIG. 10 is an explanatory diagram illustrating an example of a correlation coefficient (1). In FIG. 10, correlation information 1000 is information describing correlation coefficients representing correlations between tasks immediately before and/or after tasks “A” to “C” acquired based on attributes of workers 1 to 3 of tasks “A” to “C”. Specifically, the correlation coefficients of the same tasks are “1.0”, and other than that the correlation coefficients are “0.0”.

Now, the first calculation unit 503 applies the estimated man-hours of tasks “A” to “C” based on the input information 900 to above expressions (1) to (6). Then the unit 503 calculates, probability density distributions “e₁” to “e₃” representing estimation errors depending on workers 1 to 3 and the distributions “x₁” to “x₃” representing modeling errors depending on estimation methods for estimating man-hours of tasks “A” to “C”.

FIG. 11 is an explanatory diagram illustrating a calculation result of a first calculation unit 503 (1). In FIG. 11, calculation results 1100 provides mean values and standard deviations by tasks “A” to “C” for both probability density distributions “e₁” to “e₃”representing estimation errors depending on workers 1 to 3 and the distribution “x₁” to “x₃” representing modeling errors depending on methods for estimating man-hours of tasks “A” to “C” respectively.

The task “A” here, for example, provides a probability density distribution “e₁” representing estimation errors depending on the worker 1, (mean value, standard deviation)=(0.3, 0.7), and the distribution “x₁” representing modeling errors depending on estimation methods for estimating man-hours of the task “A” (mean value, standard deviation)=(11.0, 0.0).

Then, according to the correlation information 1000 shown in FIG. 10, the second calculation unit 504 calculates man-hours of an entire project having a series of tasks by accumulating the calculation results 1100 shown in FIG. 11 (mean values and standard deviations of probability density distributions “e₁” to “e₃” and “x₁” to “x₃”) using statistical methods. The specific examples of statistical methods to accumulate mean values and standard deviations of the distributions “e₁” to “e₃” and the distributions “x₁” to “x₃” are explained here.

The mean values of the distributions “e₁” to “e₃” are described as mean (e₁) to mean (e₃), while standard deviations are described as σ(e₁) to σ(e₃) respectively. The mean values of the distribution “x₁” to “x₃” are described as mean(x₁) to mean(x₃), the standard deviations are described as σ(x₁) to σ(x₃) respectively. The correlation coefficient representing a correlation between a task “i” and task “j” is described as “ρᵢⱼ”.

Using these mean values and standard deviations of the probability density distributions “e₁” to “e₃”, those of “x₁” to “x₃”, and correlation coefficients between tasks, values shown below for an entire project having a series of tasks are calculated using following expressions. The expression (12) calculates a mean value of modeling errors: mean(x). The expression (13) calculates a standard deviation of modeling errors: σ(x). The expression (14) calculates a mean value of estimation errors: mean(e). The expression (15) calculates a standard deviation of estimation errors σ(e).

$$\begin{matrix}mean ( x ) = mean ( {x}_{1} ) + mean ( {x}_{2} ) + mean ( {x}_{3} ) = 52 & ( 12 ) \\ σ ( x ) = σ ( {x}_{1} ) + σ ( {x}_{2} ) + σ ( {x}_{3} ) = 0 & ( 13 ) \\ \begin{matrix}mean ( e ) = mean ( {e}_{1} ) + mean ( {e}_{2} ) + mean ( {e}_{3} ) = 0.3 \\ σ ( e ) = sqrt ( {σ ( {e}_{1} )}^{2} + {σ ( {e}_{2} )}^{2} + {σ ( {e}_{3} )}^{2} + 2 \times {ρ}_{AB} \times σ ( {e}_{1} )\end{matrix} & ( 14 ) \\ \times σ ( {e}_{2} ) + 2 \times {ρ}_{BC} \times σ ( {e}_{2} ) \times σ ( {e}_{3} ) ) ≅ 2.54 & ( 15 )\end{matrix}$$

By applying the values calculated by above expressions (12) to (15) to expressions (16) and (17) shown below according to the equation “X=x+e”, a mean value: mean(x) and a standard deviation: σ(x) of an entire project having a series of tasks can be obtained as follows.

mean(X)=mean(x)+mean(e)=52.3 (16)

σ(X)=sqrt(σ(x)²+σ(e)²)=2.54 (17)

Finally, man-hours of the entire project having a series of tasks are estimated using the mean value: mean(X) and the standard deviation: σ(X) calculated by above (16) and (17). At this time, man-hours to complete a series of tasks can be estimated with any probability.

More specifically, for example, man-hours to complete a series of tasks can be estimated with a probability of 99.8% by adding the standard deviation (σ(X)) times 3 to the mean value (mean(X)) of the entire project having a series tasks as shown in an expression below.

“mean(X)+3σ(X)≅60 days”.

According to Example 1 explained above, man-hours of an entire project having a series of tasks can be estimated by taking account of estimation errors depending on experience and skill of workers 1 to 3. This reduces variations caused by differences of attributes such as skill level, thereby improves accuracy to estimate man-hours of a series of tasks.

### EXAMPLE 2

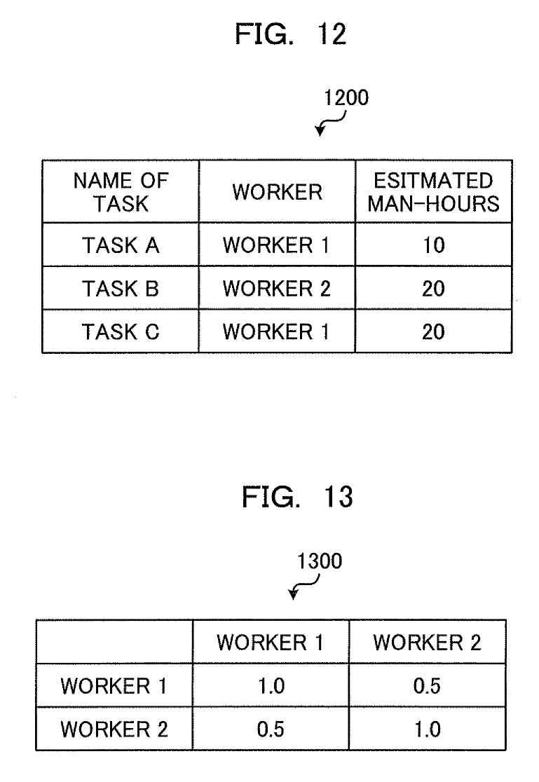

Example 2 of the above embodiment is explained. In Example 2, man-hours of an entire project having a series of tasks shown in a diagram 610 in FIG. 6 are estimated based on correlations between tasks. Firstly, input information is explained. FIG. 12 is an explanatory diagram illustrating an example of estimated man-hours of each task (2).

In FIG. 12, input information 1200 is information representing workers 1 to 3 and the estimated man-hours by tasks “A” to “C”. Specifically, the following is shown: estimated man-hours of “10 days” when a worker 1 performs a task “A”, that of “20”days when a worker 2 performs a task “B”, and that of “20”days when a worker 3 performed a task “C” respectively.

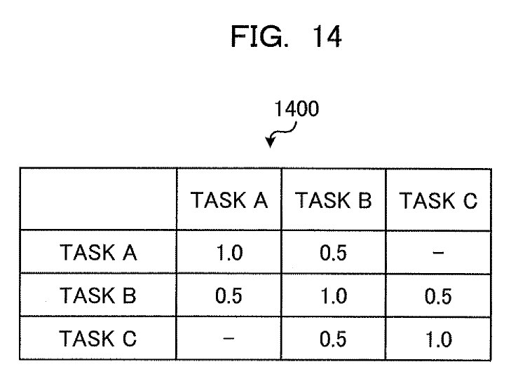

Now, a correlation table in Example 2 is explained. FIG. 13 is an explanatory diagram illustrating an example of a correlation table (2). In FIG. 13, a correlation table 1300 includes correlation coefficients representing correlations between attributes of workers 1 and 2. Specifically, the correlation coefficients between attributes of the same worker are “1.0” and the correlation coefficients between workers 1 and 2 are “0.5”.

When man-hours of an entire project having a series of tasks are estimated, firstly, an input unit 501 accepts input of input information 1200. Then an acquisition unit 502 acquires model functions from the attribute information DB300 based on attributes of workers (the workers 1 and 2) who perform tasks “A” to “C” respectively. Specifically, the acquisition unit 502 acquires above expressions (1) to (4).

Moreover, the acquisition unit 502 acquires a coefficient correlation representing a correlation between tasks in terms of estimation errors based on attributes of workers (workers 1 and 2) who perform tasks “A” to “C” respectively by referring to a correlation table 1300. By referring to the diagram 610 here, the correlation coefficient representing a correlation between tasks immediately before and/or after each task is acquired.

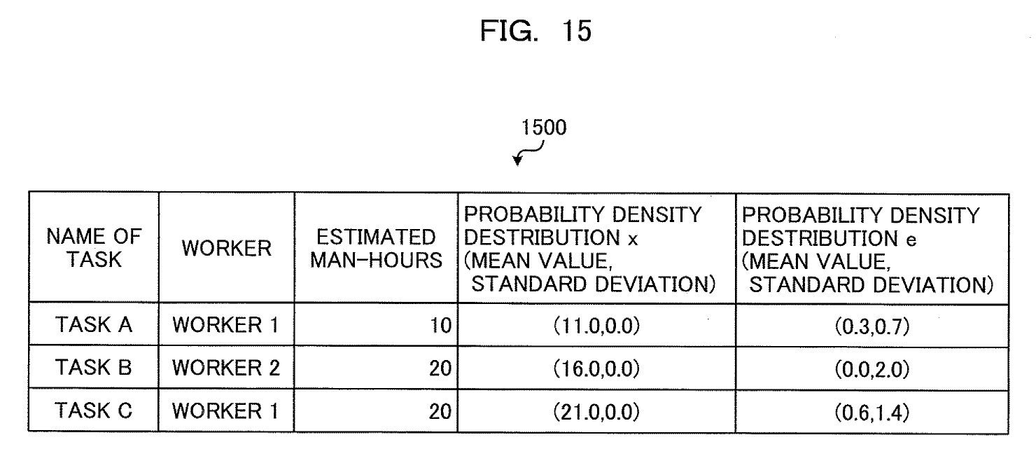

FIG. 14 is an explanatory diagram illustrating an example of a correlation coefficient (2). In FIG. 14, correlation information 1400 is information describing correlation coefficients representing correlations between tasks acquired based on attributes of workers 1 and 2 who perform tasks “A” to “C”. Specifically, the correlation coefficients of the same tasks are “1.0”, and other than that the correlation coefficients are 0.5.

Then the first calculation unit 503 applies the estimated man-hours of tasks “A” to “C” based on the input information 1200 to above expressions (1) to (4). Then the unit 503 calculates probability density distributions “e₁” and “e₂” representing estimation errors depending on workers 1 and 2 and the distributions “x₁” and “x₂” representing modeling errors depending on methods for estimating man-hours of tasks “A” to “C”.

In Example 2, a worker who performs the tasks “A” and “C” is the same worker 1. Therefore, estimated man-hours of the tasks “A” and “C” are applied to the probability density distributions “e₁” representing estimation errors depending on the worker 1, and to the “x₁” representing modeling errors depending on methods for estimating the tasks “A” and “C” respectively.

FIG. 15 is an explanatory diagram illustrating calculation results of a first calculation unit (2). In FIG. 15, a calculation result 1500 provides mean values and standard deviations for both probability density distributions “e₁” and “e₂”representing estimation errors depending on workers 1 and 2, and “x₁” and “x₂” representing modeling errors depending on methods for estimating man-hours of tasks “A” to “C” by tasks “A” to “C”.

The task “C” here, for example, provides a probability density distribution “e₁” representing estimation errors depending on the worker 1, (mean value, standard deviation)=(0.6, 1.4), and the distribution “x₁” representing modeling errors depending on methods for estimating man-hours of task “A” (mean value, standard deviation)=(21.0, 0.0).

Then, according to the correlation information 1400 shown in FIG. 14, the second calculation unit 504 calculates man-hours of an entire project having a series of tasks by using statistical methods to accumulate the calculation result 1500 in FIG. 15 (probability density distributions e₁ to e₂ and x₁ to x₂) based on the correlation information shown in FIG. 14.

The following expressions calculate values shown below for an entire project having a series of tasks. The expression (18) calculates a mean value of modeling errors: mean(x). The expression (19) calculates a standard deviation of modeling errors: σ(x). The expression (20) calculates a mean value of estimation errors: mean(e). The expression (21) calculates a standard deviation of estimation errors σ(e).

$$\begin{matrix}mean ( x ) = mean ( {x}_{1} ) + mean ( {x}_{2} ) + mean ( {x}_{3} ) = 48 & ( 18 ) \\ σ ( x ) = σ ( {x}_{1} ) + σ ( {x}_{2} ) + σ ( {x}_{3} ) = 0 & ( 19 ) \\ \begin{matrix}mean ( e ) = mean ( {e}_{1} ) + mean ( {e}_{2} ) + mean ( {e}_{3} ) = 0.9 \\ σ ( e ) = sqrt ( {σ ( {e}_{1} )}^{2} + {σ ( {e}_{2} )}^{2} + {σ ( {e}_{3} )}^{2} + 2 \times {ρ}_{AB} \times σ ( {e}_{1} )\end{matrix} & ( 20 ) \\ \times σ ( {e}_{2} ) + 2 \times {ρ}_{BC} \times σ ( {e}_{2} ) \times σ ( {e}_{3} ) ) ≅ 3.26 & ( 21 )\end{matrix}$$

By applying the values calculated by above expressions (18) to (21) to expressions (22) and (23) shown below according to the equation “X=x+e”, a mean value: mean (x) and a standard deviation: σ(x) of an entire project having a series of tasks can be obtained as follows.

mean(X)=mean(x)+mean(e)=48.9 (22)

σ(X)=sqrt(σ(x)²+σ(e)²)=3.26 (23)

Finally, man-hours of the entire project having a series of tasks are estimated using the mean value: mean(X) and the standard deviation: σ(X) calculated by above expressions (22) and (23). At this time, man-hours to complete a series of tasks can be estimated with any probability.

More specifically, for example, man-hours to complete a series of tasks can be estimated with a probability of 99.8% by adding the standard deviation (σ(X)) times 3 to the mean value (mean(X)) of the entire project having a series tasks as shown in the expression below.

“mean(X)+3×σ(X)≅59 days”

The estimated man-hours here are less than those man-hours estimated for tasks without any correlation.

According to Example 2 explained above, man-hours of an entire project having a series of tasks can be estimated by taking account of correlations between tasks in serial order depending on experience and skill of workers 1 and 2. This reduces variations caused by correlations of tasks in serial order, thereby improves accuracy to estimate man-hours of a series of tasks.

### EXAMPLE 3

Example 3 of above embodiment is explained. In Example 3, man-hours of an entire project having a series of tasks shown in a diagram 620 in FIG. 6 are estimated. Firstly, input information is explained. FIG. 16 is an explanatory diagram illustrating an example of estimated man-hours of each task (3).

In FIG. 16, input information 1600 is information representing workers 1 to 3 and the estimated man-hours by tasks “A” to “C”. Specifically, the following is shown: estimated man-hours of “5 days” when a worker 1 performs a task “A”, that of “4 days” when a worker 2 performs a task “B” and that of “5 days” when a worker 3 performs a task “C”.

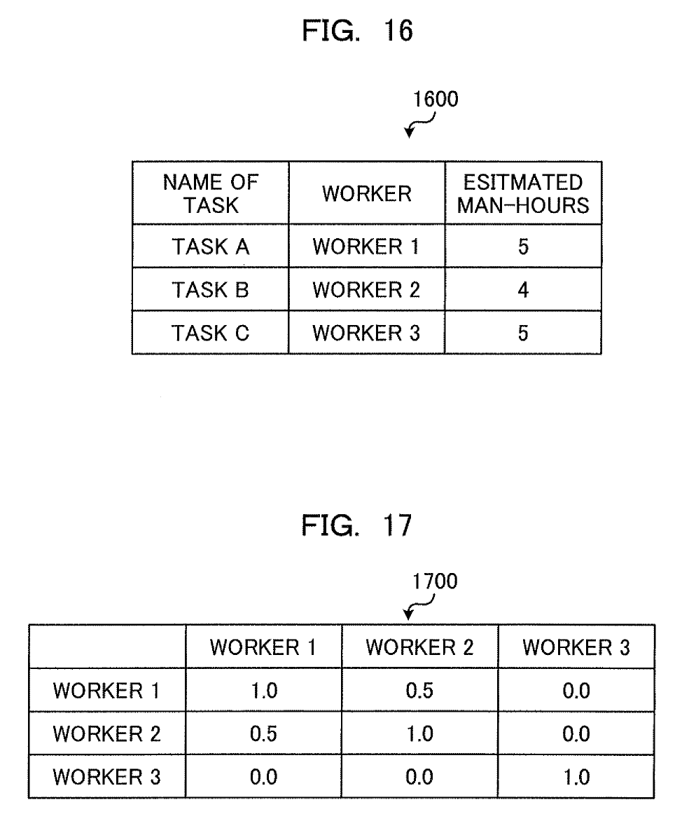

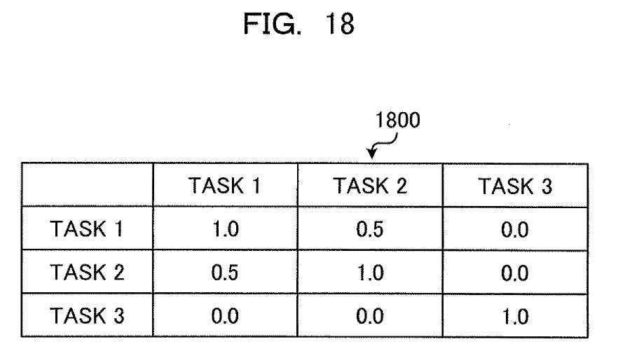

Now, a correlation table in Example 3 is explained. FIG. 17 is an explanatory diagram illustrating an example of a correlation table (3). In FIG. 17, a correlation table 1700 retains correlation coefficients representing correlations between attributes of workers 1 to 3. Specifically, the correlation coefficients between attributes of the same worker are “1”, between workers 1 and 2 are “0.5”, and between workers 2 and 3 is “0.0”.

When man-hours of an entire project having a series of tasks are estimated, firstly, an input unit 501 accepts input of input information 1600. Then an acquisition unit 502 acquires model functions from the attribute information DB300 based on attributes of workers (the workers 1 to 3) of tasks “A” to “C” respectively. Specifically, the acquisition unit 502 acquires above expressions (1) to (6).

Moreover, the acquisition unit 502 acquires a coefficient correlation representing a correlation between tasks in terms of estimation errors based on attributes of workers (workers 1 to 3) who perform tasks “A” to “C” respectively by referring to a correlation table 1700. By referring to the diagram 620 here, a correlation coefficient representing a correlation between tasks immediately before and/or after each task is acquired.

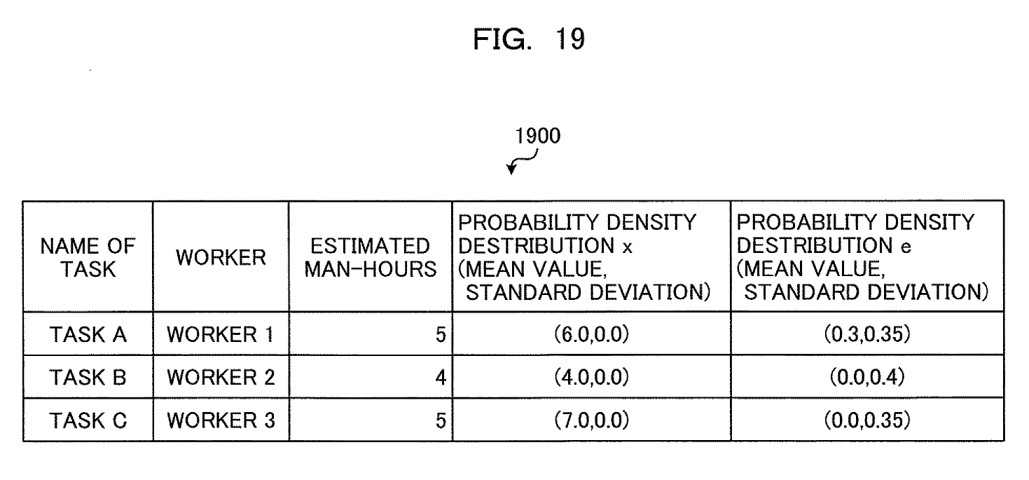

FIG. 18 is an explanatory diagram illustrating an example of a correlation coefficient (3). In FIG. 18, correlation information 1800 is information describing correlation coefficients representing correlations between tasks acquired based on attributes of workers 1 to 3 who perform tasks “A” to “C”. Specifically, the correlation coefficients of the same tasks are “1.0”, those of the tasks 1 and 2 are “0.5” and other than these the correlation coefficient is 0.0.

Then the first calculation unit 503 applies the estimated man-hours of tasks “A” to “C” based on the input information 1600 to above expressions (1) to (6). Then the unit 503 calculates probability density distributions “e₁” to “e₃” representing estimation errors depending on workers 1 to 3 and the distributions “x₁” to “x₃” representing modeling errors depending on methods for estimating man-hours of tasks “A” to “C”.

FIG. 19 is an explanatory diagram illustrating calculation results of a first calculation unit 503 (3). In FIG. 19, calculation results 1900 provides mean values and standard deviations for both probability density distributions “e₁” to “e₃” representing estimation errors depending on workers 1 to 3 and “x₁” to “x₃” representing modeling errors depending on methods for estimating man-hours of tasks “A” to “C” respectively.

The task “C” here, for example, provides a probability density distribution “e₃” representing estimation errors depending on the worker 3, (mean value, standard deviation)=(0.0, 0.35), and the distribution “x₃” representing modeling errors depending on methods for estimating man-hours of task “C” (mean value, standard deviation)=(7.0, 0.0).

Then, according to the correlation information 1800 shown in FIG. 18, the second calculation unit 504 calculates man-hours of an entire project having a series of tasks by accumulating the calculation results 1900 shown in FIG. 19 (probability density distributions “e₁” to “e₃” and “x₁” to “x₃”) using statistical methods.

The following expressions calculate values shown below for an entire project having a series of tasks. The expression (24) calculates a mean value of modeling errors: mean (x). The expression (25) calculates a standard deviation of modeling errors: σ(x). The expression (26) calculates a mean value of estimation errors: mean (e). The expression (27) calculates a standard deviation of estimation errors σ(e).

mean(x)=max(mean(x₁), mean(x₂))+mean(x₃)=13 (24)

σ(x)=max(σ(x₁), σ(x₂))+σ(x₃)=0 (25)

mean(e)=max(mean(e₁), mean(e₂))+mean(e₃)=0.3 (26)

σ(e)=sqrt(max(σ(e₁), σ(e₂))²+σ(e₃)²)=0.2825 (27)

The values calculated by above expressions (24) to (27) are applied to expressions (28) and (29) shown below to obtain a mean value: mean(X) and a standard deviation: σ(x) of an entire project having a series of tasks as follows.

mean(X)=mean(x)+mean(e)=13.3 (28)

σ(X)=sqrt(σ(x)²+σ(e)²)=0.2825 (29)

Finally, man-hours of the entire project having a series of tasks are estimated according to an equation “Xi=xᵢ+eᵢ” explained by using FIG. 1. At this time, man-hours to complete a series of tasks can be estimated with any probability. For example, man-hours to complete a series of tasks can be estimated with a probability of 99.8% by adding the standard deviation (σ(X)) times 3 to the mean value (mean(X)) of the entire project having a series tasks as shown in an expression below.

“mean(x)+3×σ(X)≅14 days”

The cases when no correlation exists between the tasks 1 and 3 and tasks 2 and3 respectively have been explained by now. However, cases are not limited to these. For example, when correlation exists between tasks 1 and 3, and tasks 2 and 3, standard deviations of estimation error σ(e)shown in above expression (27) can be calculated by using an approximation such as shown in (30).

σ(e)≅sqrt(max(σ(e₁), σ(e₂))2+σ(e₃)2)+2×max(ρ13×σ(e₁)×σ(e₃), ρ23×σ(e₂)×σ(e₃)) (30)

According to Example 3 explained above, man-hours of an entire project having a series of tasks can be estimated by taking account of correlations between tasks in parallel depending on experience and skill of workers 1 to 3. This reduces variations caused by correlations of tasks in parallel order, thereby improves accuracy to estimate man-hours of a series of tasks. Using an approximation such as the expression (30) and taking account of correlations between tasks in series and in parallel enable to realize estimation of man-hours with higher accuracy.

### EXAMPLE 4

An example 4 of above embodiment is explained. In Example 4, embodiment of output by an output unit 505 is explained. FIG. 20 is an explanatory diagram illustrating an output format displayed on a display. In FIG. 20, a display 231 displays estimation results 2000 for an entire project having a plurality of tasks “A” to “E”.

More specifically, estimated man-hours of tasks “A” to “E” (i.e., G1 to G5 in FIG. 20) corresponding to the “A” to “E” represented in a diagram 2010 are shown graphically. Moreover, statistically accumulated estimated man-hours of an entire project having a series of tasks are graphically shown (i.e., G6 in FIG. 20)

The graphs G1 to G6 are divided into areas “P” and “Q” representing modeling errors depending on methods for estimating man-hours of tasks “A” to “E” respectively, and an area “R” representing estimation error depending on an attribute of each worker. The graph shows estimated man-hours to complete each of tasks “A” to “E” and a series of tasks with a probability of 50% and those with 99% as well.

According to Example 4 explained above, estimation errors depending on experience and skill of workers who perform tasks “A” to “E” in addition to estimated man-hours of an entire project having a series of tasks can be graphically shown. These visual representations of man-hours of tasks A to E and an entire project having a series of tasks by separating modeling errors and estimation errors allow easier understanding of estimation results by a user.

As explained above, according to the man-hours estimation program, storage medium which stored the program, the man-hours estimation apparatus, and the method, accuracy to estimate man-hours of an entire project having a series of tasks can be improved by taking account of estimation errors depending on an attribute of a worker included in estimated man-hours of each task.

The methods to estimate man-hours explained in this embodiment can be realized by causing a computer such as a personal computer and a workstation to execute a prepared program. Such program is stored in a computer-readable storage medium such as a hard disk, a flexible disk, compact disc ROM (CD-ROM), magneto-optical (MO) disk, and digital versatile disk (DVD), and executed by a computer. The program may be transmission medium distributable through a network such as Internet.

As explained above, the man-hours estimation program, the storage medium which stored the program, the man-hours estimation apparatus and the method are advantageous when estimating man-hours of development having a plurality of development processes.

Although a few preferred embodiments of the present invention have been shown and described, it would be appreciated by those skilled in the art that changes may be made in these embodiments without departing from the principles and spirit of the invention, the scope of which is defined in the claims and their equivalents.

What is claimed is:

1. A method for estimating man-hours of an entire project having a series of tasks with a computer comprising:
inputting an estimated man-hours of the each task,
acquiring model functions for extracting estimation errors included in the estimated man-hours of the each task based on an attribute of a worker who performs the each task;
calculating a probability density distribution representing estimation errors depending on the attribute and a probability density distribution representing modeling errors depending on methods for estimating the man-hours for each task using the model functions;
calculating man-hours of the entire project having a series of tasks for the each task using statistical methods to accumulate the probability density distribution representing estimation errors and the probability density distribution representing the modeling errors; and
outputting calculating results of man-hours of the entire project to an output device.

2. The method for estimating man-hours according to claim 1, further comprising;
acquiring a correlation coefficient representing a correlation between the tasks in terms of the estimation errors based on an attribute of a worker who performs the each task; and
calculating man-hours of the entire project having a series of tasks by using statistical methods to accumulate the probability density distribution representing the estimation errors and the probability density distribution representing the modeling errors based on the correlation coefficient.

3. The method for estimating man-hours according to claim 2, further comprising;
acquiring a correlation coefficient representing a correlation between tasks in terms of the estimation errors based on an attribute of a worker who performs the each task immediately before and/or after the each task by referring to a sequence of the series of tasks.

4. The method for estimating man-hours according to claim 2, further comprising;
acquiring a correlation coefficient representing a correlation between serially connected tasks by referring to a sequence of the series of tasks in terms of the estimation errors based on an attribute of a worker who performs the each task.

5. The method for estimating man-hours according to claim 1, further comprising;
updating parameter values in model functions retained by being linked to the worker's attribute of the task based on the estimated man-hours and actual man-hours spent for the task; and
acquiring updated model functions retained by being linked to the attribute when the parameter values are updated.

6. The method for estimating man-hours according to claim 1, further comprising;
outputting the probability density representing man-hours of the entire project having a series of tasks and the probability density representing estimation errors included in the estimated man-hours of the entire project having a series of tasks to the output device.

7. The method for estimating man-hours according to claim 1, wherein;
the attribute is personal information of a worker who performs the each task.

8. The method for estimating man-hours according to claim 1, wherein;
the attribute is skill level of a worker who performs the each task.

9. An apparatus for estimating man-hours of an entire project having a series of tasks, comprising:
an input unit that accepts estimated man-hours of the each task;
an acquisition unit that acquires model functions for extracting estimation errors included in the estimated man-hours of the each task input by the input unit based on an attribute of a worker who performs the each task;
a first calculation unit that calculates a probability density distribution representing estimation errors depending on the attributes and a probability density distribution representing modeling errors depending on methods for estimating the man-hours for each of the tasks using the model functions acquired by the acquisition unit;
a second calculation unit that calculates man-hours of the entire project having a series of tasks for the each task using statistical methods to accumulate the probability density distribution representing estimation errors and the probability density distribution representing modeling errors calculated by the first calculation unit; and
an output device that outputs results calculated by the second calculation unit.

10. The apparatus for estimating man-hours according to claim 9, wherein;
the acquisition unit further acquires a correlation coefficient representing a correlation between the tasks in terms of the estimation errors based on an attribute of a worker who performs the each task; and
the second calculation unit calculates man-hours of the entire project having a series of tasks by using statistical methods to accumulate the probability density distribution representing the estimation errors and the probability density distribution representing the modeling errors based on the correlation coefficient acquired by the acquisition unit.

11. The apparatus for estimating man-hours according to claim 10, wherein;
the acquisition unit acquires a correlation coefficient representing a correlation between tasks immediately before and/or after the each task by referring to a sequence of the series of tasks.

12. The apparatus for estimating man-hours according to claim 10, wherein;
the acquisition unit acquires a correlation coefficient representing a correlation between serially connected tasks by referring to a sequence of the series of tasks.

13. The apparatus for estimating man-hours according to claim 9, further comprising;
an update unit that updates parameter values in model functions retained by being linked to the worker's attribute of the task based on the estimated man-hours and actual man-hours spent for the task; and
the acquisition unit acquires updated model functions retained by being linked to the attribute when the parameter values are updated.

14. The apparatus for estimating man-hours according to claim 9, wherein;
the output device displays the probability density representing man-hours of the entire project having a series of tasks and the probability density representing estimation errors included in the estimated man-hours of the entire project having a series of tasks.

15. A computer-readable storage medium that stores a program causing a computer to operate estimation processes of man-hours of an entire project having a series of tasks, the estimation processes comprising:
inputting an estimated man-hours of the each task,
acquiring model functions for extracting estimation errors included in the estimated man-hours of the each task based on an attribute of a worker who performs the each task;
calculating a probability density distribution representing estimation errors depending on the attribute and a probability density distribution representing modeling errors depending on methods for estimating the man-hours for each task using the model functions;
calculating man-hours of the entire project having a series of tasks for the each task using statistical methods to accumulate the probability density distribution representing estimation errors and the probability density distribution representing the modeling errors; and
outputting calculating results of man-hours of the entire project to an output device.

16. The computer-readable storage medium according to claim 15, further comprising;
acquiring a correlation coefficient representing a correlation between the tasks in terms of the estimation errors based on an attribute of a worker who performs the each task; and
calculating man-hours of the entire project having a series of tasks by using statistical methods to accumulate the probability density distribution representing the estimation errors and the probability density distribution representing the modeling errors based on the correlation coefficient.

17. The computer-readable storage medium according to claim 16, wherein,
acquiring a correlation coefficient representing a correlation between tasks in terms of the estimation errors based on an attribute of a worker who performs the each task immediately before and/or after the each task by referring to a sequence of the series of tasks.

18. The computer-readable storage medium according to claim 16 wherein,
acquiring a correlation coefficient representing a correlation between serially connected tasks by referring to a sequence of the series of tasks in terms of the estimation errors based on an attribute of a worker who performs the each task.

19. The computer-readable storage medium according to claim 15, further comprising:
updating parameter values in model functions retained by being linked to the worker's attribute of the task based on the estimated man-hours and actual man-hours spent for the task; and
acquiring updated model functions retained by being linked to the attribute when the parameter values are updated.

20. The computer-readable storage medium according to claim 15 wherein,
outputting the probability density representing man-hours of the entire project having a series of tasks and the probability density representing estimation errors included in the estimated man-hours of the entire project having a series of tasks to the output device.
